(19) United States
(12) Patent Application Publication
(10) Pub. No.: US 2005/0264206 A1
(43) Pub. Date: Dec. 1, 2005

(54) Plasma display panel

(75) Inventors: Masaki Yoshinari, Yamanashi-ken (JP); Takashi Yamada, Yamanashi-ken (JP); Yoichi Okumura, Yamanashi-ken (JP); Tasuku Ishibashi, Yamanashi-ken (JP)

Correspondence Address: ARENT FOX PLLC, 1050 CONNECTICUT AVENUE, N.W., SUITE 400, WASHINGTON, DC, 20036, US

(73) Assignee: Pioneer Corporation

(21) Appl. No.: 11/127,185

(22) Filed: May 12, 2005

(30) Foreign Application Priority Data
May 26, 2004 (JP) JP2004-156017
Mar. 2, 2005 (JP) JP2005-057310

(51) Int. Cl. H01J 11/02; H01J 17/49

(52) U.S. Cl. 313/586

(57) ABSTRACT

Sustain electrodes and a transparent dielectric layer covering the sustain electrodes are formed on the rear-facing face of the front glass substrate. A plurality of first additional dielectric layers protrude from the rear-facing face of the transparent dielectric layer, extend in the column direction and are regularly arranged in the row direction. An address electrode initiating a discharge in conjunction with the sustain electrode is formed on each of the first additional dielectric layers.

### BACKGROUND OF THE INVENTION

1. Field of the Invention

This invention relates to the panel structure of surface-discharge-type alternating-current plasma display panels.

The present application claims priority from Japanese Applications No. 2004-156017 and No 2005-57310, the disclosure of which is incorporated herein by reference.

2. Description of the Related Art

Some surface-discharge-type alternating-current plasma display panels (herein after referred to as “PDP”) have a structure, as shown in FIGS. 1 and 2, in which sustain electrode pairs and address electrodes are both formed on one glass substrate of a pair of glass substrates facing each other across the discharge space.

The PDP illustrated in FIGS. 1 and 2 has sustain electrode pairs (X, Y) formed on the rear-facing face (i.e. the face facing toward the rear of the PDP) of a front glass substrate 1 serving as the display surface of the PDP. The sustain electrode pairs (X, Y) extend in the row direction (the right-left direction in FIG. 1) and are regularly arranged in the column direction (the vertical direction in FIG. 1).

Each of the sustain electrodes X and Y constituting each sustain electrode pair (X, Y) is composed of a bus electrode Xa (Ya) extending in a bar shape in the row direction and transparent electrodes Xb (Yb) spaced at regular intervals along the bus electrode Xa (Ya) and each extending out to face the counterpart transparent electrodes Yb (Xb) with a discharge gap g in between.

A first dielectric layer 2 is formed on the rear-facing face of the front glass substrate 1 so as to cover the sustain electrode pairs (X, Y).

Address electrodes D are regularly arranged in the row direction on the rear-facing face of the first dielectric layer 2. Each of the address electrodes D extends in the column direction along a strip area opposite to the positions between two transparent electrodes Xb (Yb) regularly spaced in the row direction in each sustain electrode X (Y). The address electrodes D are covered by a second dielectric layer 3 formed on the rear-facing face of the first dielectric layer 2.

Additional dielectric layers 4 project toward the rear of the PDP from the rear-facing face of the second dielectric layer 3. Each of the additional dielectric layers 4 extends in the column direction opposite to the address electrode D.

On the rear-facing faces of the second dielectric layer 3 and the additional dielectric layers 4, a protective layer (not shown) formed of high y dielectrics, such as MgO, is provided.

The front glass substrate 1 is positioned opposite to a back glass substrate 5 with a discharge space in between. A white dielectric layer 6 is formed on the front-facing face of the back glass substrate 5. A partition wall unit 7 is formed on the white dielectric layer 6. The partition wall unit 7 is shaped substantially in a grid form of vertical walls 7A and transverse walls 7B. Each of the vertical walls 7A extends in the column direction opposite to the address dielectric D. Each of the transverse walls 7B extends in the row direction along a strip area opposite to the strip area between bus electrodes Xa and Ya of the back-to-back sustain electrodes X and Y of the adjacent sustain electrode pairs (X, Y).

This partition wall unit 7 partitions the discharge space between the front glass substrate 1 and the back glass substrate 5 into areas each corresponding to the paired transparent electrodes Xb and Yb of each sustain electrode pair (X, Y) to form discharge cells C.

Red-, green- and blue-colored phosphor layers 8 are formed on the side faces of the partition wall unit 7 and the faces of the front glass substrate 5 surrounded by the partition wall unit 7, and arranged in order in the row direction.

The discharge space is filled with a discharge gas including xenon (Xe).

Such a conventional PDP is disclosed in Japanese Patent Laid-open publication 2003-257321, for example.

In the aforementioned PDP, a reset discharge is produced between the sustain electrodes X and Y or between the sustain electrode Y and the address electrode D. Then, an address discharge is produced selectively between the transparent electrode Yb of the sustain electrode Y and the address electrode D, resulting in the deposition of wall charge on the first dielectric layer 2 and the second dielectric layer 3 facing the discharge cell C in which the address discharge has been produced.

Under these conditions, a sustain pulse is applied alternately to the sustain electrodes X and Y in each sustain electrode pair (X, Y), to initiate a sustain discharge in the discharge cell C (light-emitting cell) having the deposition of wall charge on the first dielectric layer 2 and the second dielectric layer 3.

By means of the sustain discharge, vacuum ultraviolet light is emitted from the xenon in the discharge gas filling the light-emitting cell, and excites the red-, green- and blue-colored phosphor layers 8. Thereupon, the phosphor layers 8 emit visible light, thus generating an image on a matrix display.

In the PDP structured as described above, the sustain electrode pairs (X, Y) and the address electrodes D are formed on the front glass substrate 1. Therefore, the PDP has advantages such as ease of alignment between the substrates in the manufacturing process as compared with a PDP having sustain electrode pairs formed on one of the pair of front and back glass substrates and address electrodes formed on the other.

However, when the sustain electrode pairs and the address electrodes are formed on the same glass substrate as described earlier, as compared with the PDP having the sustain electrode pairs and the address electrodes formed separately on the two opposing glass substrates, the discharge initiated between the sustain electrode and the address electrode is approximate surface discharge and therefore the occurrence of a discharge becomes difficult. As a result, the discharge voltage tends to be raised and the address voltage margin narrowed. Further, the sustain electrode and the address electrode are positioned so close to each other that a space is not formed between them. Hence, a large electrostatic capacity is generated between the sustain and address electrodes, resulting in the problem of an increase in electric power consumption.

### SUMMARY OF THE INVENTION

An object of the present invention is to solve the problems associated with the surface-discharge-type alternating-current PDPs having sustain electrodes and address electrodes on one of the substrates as described above.

To attain this object, according to a first feature of the present invention, there is provided a plasma display panel comprising: a front substrate and a back substrate placed opposite each other on either side of a discharge space; a plurality of row electrode pairs extending in the row direction and regularly arranged in the column direction on the rear-facing face of the front substrate; a dielectric layer formed on the rear-facing face of the front substrate and covering the row electrode pairs; a plurality of column electrodes extending in the column direction, regularly arranged in the row direction and initiating a discharge in conjunction with the row electrode in each unit light-emitting area formed in the discharge space; and a plurality of first ridged dielectric layers that protrude from the rear-facing face of the dielectric layer and extend in the column direction and are regularly arranged in the row direction, in which each of the column electrodes is formed on the first ridged dielectric layer.

To attain the above object, according to a second feature of the present invention, there is provided a plasma display panel comprising: a front substrate and a back substrate placed opposite each other on either side of a discharge space; a plurality of row electrode pairs extending in the row direction and regularly arranged in the column direction on the rear-facing face of the front substrate; a dielectric layer formed on the rear-facing face of the front substrate and covering the row electrode pairs; a plurality of column electrodes extending in the column direction, regularly arranged in the row direction and initiating a discharge in conjunction with the row electrode in each unit light-emitting area formed in the discharge space; and a partition wall unit formed on the back substrate and extending at least in the column direction to block off the unit light-emitting areas adjacent to each other in the row direction from each other, with the column electrodes being formed on the partition wall unit.

In a PDP according to an embodiment of the present invention, an address electrode initiating a discharge in conjunction with one sustain electrode of a sustain electrode pair is formed on the leading face of a first additional dielectric layer formed on the rear-facing face of a transparent dielectric layer in such a manner as to protrude from the rear-facing face of the transparent dielectric layer that is formed on the rear-facing face of the front glass substrate and covers the sustain electrode pairs. Alternatively, the address electrode is formed on the leading face of a partition wall unit formed on the back glass substrate.

The plasma display panel in the embodiment is a plasma display panel having the address electrodes formed on the front glass substrate. The distance between each of the address electrodes and each of the sustain electrodes between which a discharge is produced is increased as compared with a conventional PDP. Further, a space is interposed between the address electrode and the sustain electrode. This makes the electrostatic capacity between the address and sustain electrodes lower to reduce the electric power consumption.

Further, the address electrode is positioned substantially in the thickness direction of the panel with respect to the sustain electrode. Therefore, the address discharge caused between the address and sustain electrodes is an approximate opposing discharge. This facilitates the occurrence of a discharge, leading to a drop in the address discharge voltage and widening of the address voltage margin.

These and other objects and features of the present invention will become more apparent from the following detailed description with reference to the accompanying drawings.

### BRIEF DESCRIPTION OF THE DRAWINGS

FIG. 1 is a front view illustrating an example of the related art.

FIG. 2 is a sectional view taken along the II-II line in FIG. 1.

FIG. 3 is a schematic front view illustrating a first embodiment according to the present invention.

FIGS. 4A and 4B are-sectional views taken along the IV-IV line in FIG. 3.

FIG. 5 is a flowchart illustrating the manufacturing process for the plasma display panel according to the first embodiment.

FIG. 6 is a schematic front view illustrating a second embodiment according to the present invention.

FIG. 7 is a sectional view taken along the VII-VII line in FIG. 6.

FIG. 8 is a flowchart illustrating the manufacturing process for the plasma display panel according to the second embodiment.

FIG. 9 is a sectional view illustrating a modified example of the second embodiment.

FIG. 10 is a sectional view illustrating a third embodiment according to the present invention.

FIG. 11 is a sectional view illustrating a fourth embodiment according to the present invention.

FIG. 12 is a sectional view illustrating a fifth embodiment according to the present invention.

FIG. 13 is a schematic front view illustrating a sixth embodiment according to the present invention.

FIG. 14 is a sectional view taken along the XIV-XIV line in FIG. 13.

FIG. 15 is a front view illustrating a modified example of the sixth embodiment.

### DETAILED DESCRIPTION OF THE PREFERRED EMBODIMENTS

### First Embodiment

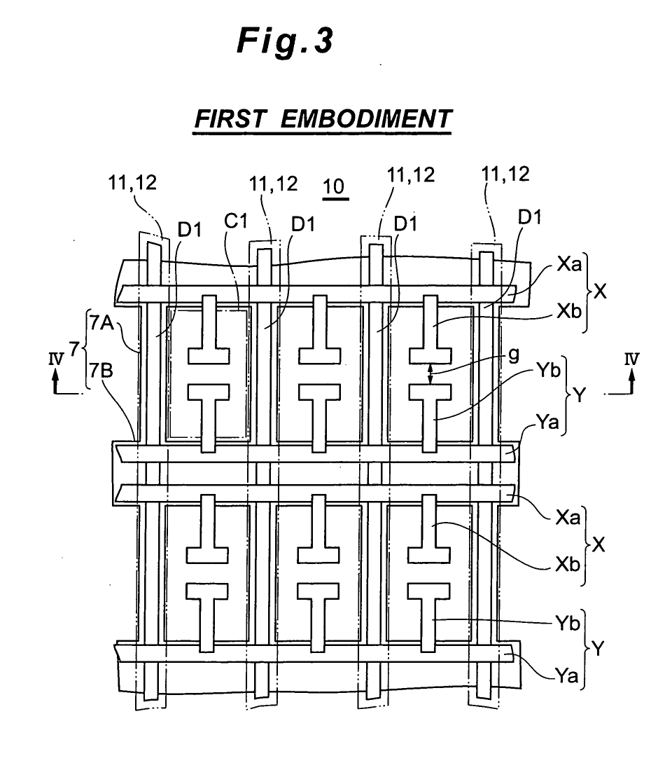

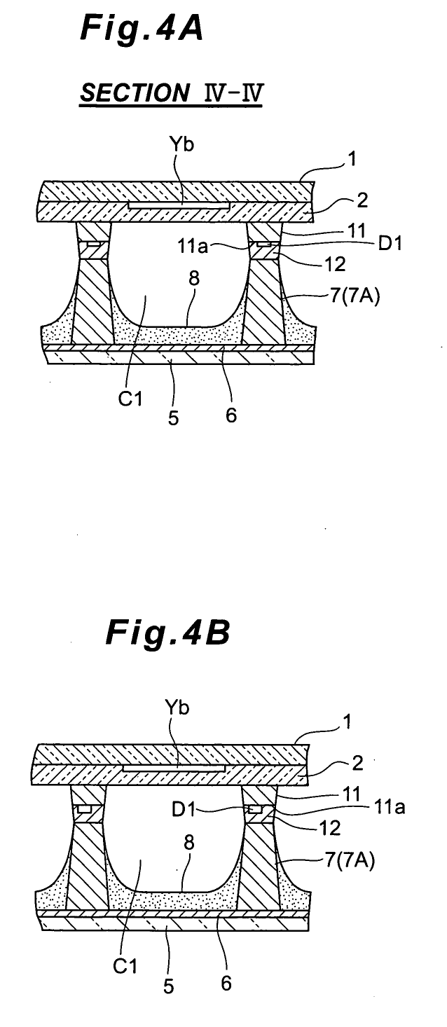

FIGS. 3 and 4 illustrate a first embodiment of a PDP according to the present invention. FIG. 3 is a schematic front view of the PDP in the first embodiment. FIGS. 4A and 4B are sectional views taken along the IV-IV line in FIG. 4.

In FIGS. 3, 4A and 4B, the PDP 10 has a plurality of sustain electrode pairs (X, Y) extending in the row direction (the right-left direction in FIG. 3) and regularly arranged in the column direction (the vertical direction in FIG. 3) on the rear-facing face of a front glass substrate 1 which serves as the display surface of the PDP.

Each of the sustain electrodes X and Y constituting a sustain electrode pair (X, Y) is composed of a bus electrodes Xa (Ya) extending in a bar shape in the row direction, and transparent electrodes Xb (Yb) which are spaced at regular intervals along the bus electrode Xa (Ya) and each extend from the bus electrode Xa (Ya) toward their counterparts in the sustain electrode pair, so that the transparent electrodes Xb and Yb face each other across a discharge gap g.

A transparent dielectric layer 2 is formed on the rear-facing face of the front glass substrate 1 so as to cover the sustain electrode pairs (X, Y).

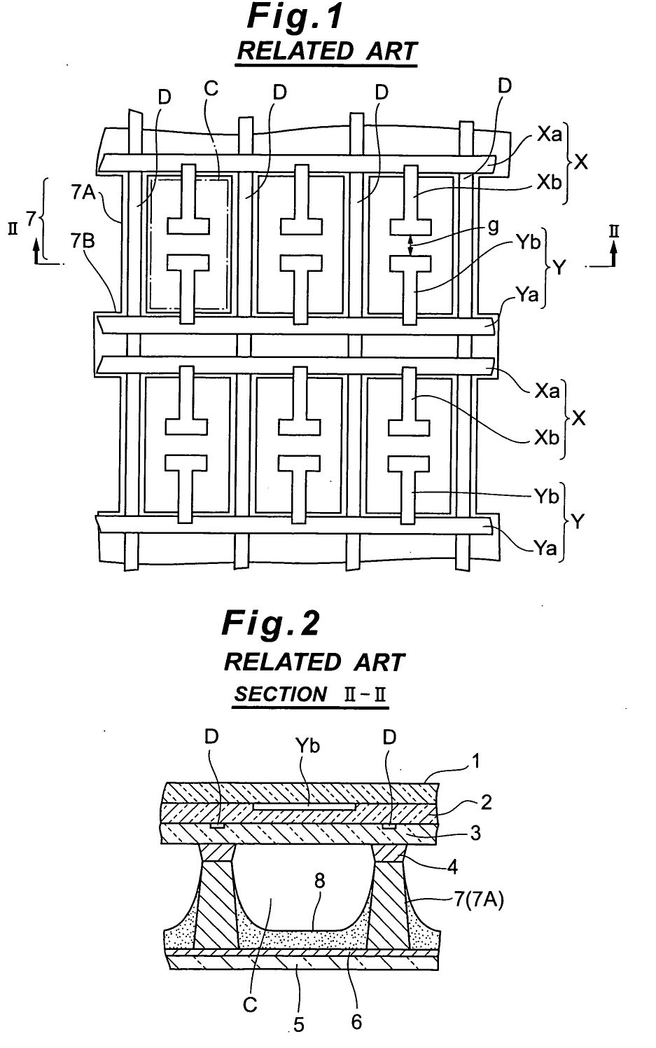

The above structure is the same as the structure of the conventional PDP illustrated in FIGS. 1 and 2. The same components are designated by the same reference numerals.

First additional dielectric layers 11 are spaced at regular intervals in the row direction on the rear-facing face of the transparent dielectric layer 2. Each of the first additional dielectric layers 11 protrudes from the rear-facing face of the transparent dielectric layer 2 and extends in the column direction along a strip area opposite to approximately intermediate positions between two transparent electrodes Xb (Yb) regularly spaced in the row direction along the bus electrode Xa(Ya) in each sustain electrode X (Y).

Each of the first additional dielectric layers 11 has a leading face 11a facing toward and parallel to the back glass substrate 5. An address electrode D1 extends in the column direction on the leading face 11a.

In this case, the address electrode D1 can be formed, as illustrated in FIG. 4A, in a central portion of the leading face 11a of the first additional dielectric layer 11, namely, a position corresponding to the intermediate position between the transparent electrodes Xb (Yb) arranged in the row direction. However, as shown in FIG. 4B, the address electrode D1 is formed preferably, on the leading face 11a of the first additional dielectric layer 11, in a position shifted in the direction of the transparent electrode Yb which is to be paired with this address electrode D1 (on the left hand in FIG. 4B in the example), in order to ensure the initiation of an address discharge between the address electrode D1 and the transparent electrode Yb and prevent a false discharge between the address electrode D1 and an adjacent unrelated transparent electrode Yb.

A second additional dielectric layer 12 is formed on and alongside the first additional dielectric layer 11 and covers the address electrode D1 formed on the leading face 11a of the first additional dielectric layer 11.

A protective layer (not shown) formed of a high γ dielectric material such as MgO is formed on the surfaces of the transparent dielectric layer 2, the first additional dielectric layers 11 and the second additional dielectric layers 12, and covers these surfaces.

On the front-facing face of the back glass substrate 5 placed opposite the front glass substrate 1 with a discharge space in between, a white dielectric layer 6 is formed. A partition wall unit 7 is formed on the white dielectric layer 6, and in an approximate grid shape of vertical walls 7A and second transverse walls 7B. Each of the vertical walls 7A extends in the column direction along a strip area opposite to the address electrode D1. Each of the transverse walls 7B extends in the row direction along a strip area opposite to the bus electrodes Xa and Ya of the back-to-back sustain electrodes X and Y of the adjacent sustain electrode pairs (X, Y) and the area between the bus electrodes Xa and Ya.

Red-, green- and blue-colored phosphor layers 8 are each formed on five faces: the side faces of the two vertical walls 7A and the two transverse walls 7B of the partition wall unit 7 and the face of the white dielectric layer 6 surrounded by the partition wall unit 7. The red-, green- and blue-colored phosphor layers 8 are arranged in order in the row direction.

The structure on the back glass substrate 5 as described above is the same as that in the conventional PDP described in FIGS. 1 and 2. The same components are designated by the same reference numerals.

The partition wall unit 7 partitions the discharge space defined between the front glass substrate 1 and the back glass substrate 5 into areas each corresponding to the opposing paired transparent electrodes Xb and Yb in each sustain electrode pair (X, Y), to form discharge cells C1.

The discharge space between the front and back glass substrates 1 and 5 is filled with a discharge gas including xenon (Xe).

The above-mentioned PDP 10 generates an image as follows.

A reset discharge is first produced simultaneously between the sustain electrodes X and Y or between the sustain electrode Y and the address electrode D1 in all the discharge cells C1. As a result, the wall charge is erased from every portions of the transparent dielectric layer 2 facing the discharge cells C1 (or wall charge is accumulated on every portions of the transparent dielectric layer 2 facing the discharge cells C1).

Then, a scan pulse is sequentially applied to one sustain electrode (the sustain electrode Y in this example) of the sustain electrode pair (X, Y), and a data pulse corresponding to the display data of the image signal is applied to the address electrode D1. Thereupon, between the address electrode D1 to which the data pulse is applied and the transparent electrode Yb of the sustain electrode Y paired with this address electrode D1, an address discharge is produced selectively in the discharge cells C1.

The address discharge results in the deposition of wall charge on the portion of the transparent dielectric layer 2 facing each of the discharge cells C1 in which the address discharge is produced (or the erasure of the wall charge on the transparent dielectric layer 2). Thus, the discharge cells C1 (light-emitting cells) each having the deposition of wall charge on the portion of the transparent dielectric layer 2 facing the discharge cell C1, and the discharge cells C1 (non-light-emitting cells) having no wall charge are distributed over the panel face.

Following that, a sustain pulse is applied to the sustain electrodes X and Y. Thereupon, a sustain discharge is initiated across the discharge gap between the opposing transparent electrodes Xb and Yb of the sustain electrodes X and Y in each of the discharge cells C1 (light-emitting cells) having the deposition of wall charge on the transparent dielectric layer 2.

In each of the discharge cells (light-emitting cells) C1, the sustain discharge allows vacuum ultraviolet light to be generated from the xenon included in the discharge gas. The vacuum ultraviolet light excites the red-, green- and blue-colored phosphor layers 8 to cause them to emit color light, thereby forming an image on matrix display.

In the PDP 10, each of the address electrodes D1 is formed on the leading face 11a of the first additional dielectric layer 11 protruding toward the back glass substrate 5 from the rear-facing face of the transparent dielectric layer 2. Because of this design, the distance between the address electrode D1 and the transparent electrode Yb of the sustain electrode Y between which an address discharge is initiated is increased as compared with that in a conventional PDP. Further, as seen from FIGS. 4A and 4B, because a space is interposed between the address electrode D1 and the transparent electrode Yb of the sustain electrode Y, the electrostatic capacity between these electrodes is reduced and therefore the electrical power consumption is reduced.

Further, the address electrode D1 is located substantially in the thickness direction of the panel with respect to the transparent electrode Yb of the sustain electrode Y. Hence, the address discharge initiated between these electrodes is an approximate opposite discharge. This facilitates the ease of occurrence of a discharge, leading to a drop in the address discharge voltage and widening of the address voltage margin.

The following are the reasons why the electrostatic capacity between the address electrode D1 and the transparent electrode Yb of the sustain electrode Y is reduced and the electric power consumption is reduced in the PDP 10.

Electric current typically flows when a potential difference is produced between electrodes. The larger the current flow, the larger the electrostatic capacity between the electrodes. In the PDP, the current generated by this electrostatic capacity is reactive current.

In the conventional PDP in FIG. 2, most of the electrostatic capacity between the address electrode D and the transparent electrode Yb of the sustain electrode Y is produced by the first dielectric layer 2 interposed between the address electrode D and the transparent electrode Yb. The distance between the address electrode D and the transparent electrode Yb is short. Thereby, the electrostatic capacity is increased.

However, in the PDP 10, most of the electrostatic capacity between the address electrode D1 and the transparent electrode Yb of the sustain electrode Y is produced by the transparent dielectric layer 2 and the first additional dielectric layer 11 which are interposed between the address electrode D1 and the transparent electrode Yb. Therefore, the distance between the address electrode D1 and the transparent electrode Yb is greater than that of the conventional PDP. Thereby, the electrostatic capacity is reduced in the PDP 10.

From the foregoing, it is possible to further reduce the electrostatic capacity between the address electrode D1 and the transparent electrode Yb if the first additional dielectric layer 11 causing the electrostatic capacity between the address electrode D1 and the transparent electrode Yb of the sustain electrode Y is formed of a dielectric material having a small relative dielectric constant, or alternatively the thickness of the first additional dielectric layer 11 is increased.

Further, the electrostatic capacity between these electrodes can be reduced by using a dielectric material having a small relative dielectric constant to form the second additional dielectric layer 12 because the second additional dielectric layer 12 is also closely involved in the occurrence of the electrostatic capacity between the address electrode D1 and the transparent electrode Yb.

Although the transparent dielectric layer 2 is also closely involved in the occurrence of the electrostatic capacity between the address electrode D1 and the transparent electrode Yb, the transparent dielectric layer 2 needs to be formed of a transparent dielectric material because of its location closer to the display surface of the panel. For this reason, it is difficult to reduce the relative dielectric constant of the transparent dielectric layer 2.

The first additional dielectric layer 11 is not required to be formed of a transparent dielectric material, as is the transparent dielectric layer 2. Hence, it is possible to reduce the relative dielectric constant of the first additional dielectric layer 11 for a reduction in electrostatic capacity.

For example, when the transparent dielectric layer 2 has a relative dielectric constant of around ten, the relative dielectric constant of the first dielectric layer 11 is preferably set at a value falling within the range from about one to about ten.

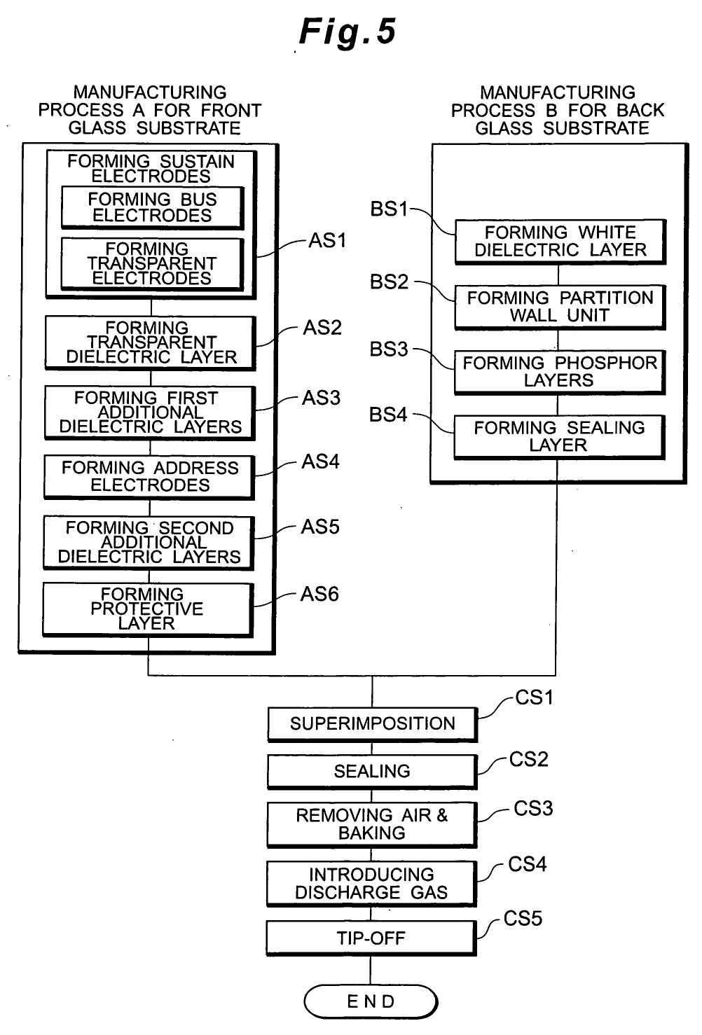

FIG. 5 shows a flowchart of the manufacturing process of the PDP 10.

Next, the manufacturing process for the PDP 10 will be described with reference to FIG. 5.

In the manufacturing process A for the front glass substrate 1, sustain electrodes X and Y are first formed on the rear-facing face of the front glass substrate 1 (step AS1).

Step AS1 includes the step of forming the bus electrodes Xa and Ya of the sustain electrodes X and Y and the step of forming the transparent electrodes Xb and Yb thereof.

After the sustain electrode pairs (X, Y) have been formed in step AS1, a transparent dielectric layer 2 is formed on the rear-facing face of the front glass substrate 1 (step AS2), so as to cover the sustain electrode pairs (X, Y) which have been formed in step AS1.

After step AS2, first additional dielectric layers 11 are formed in predetermined positions on the rear-facing face of the transparent dielectric layer 2 by a method such as pattern-printing of a dielectric paste or burning (step AS3).

After the first additional dielectric layers 11 have been formed in step AS3, address electrodes D1 are respectively formed on the leading faces la of the first additional dielectric layers 11 (step AS4).

After the address electrodes D1 have been formed on the respective leading faces 11a of the first additional dielectric layers 11 in step AS4, second additional dielectric layers 12 are formed to lie on the respective first additional dielectric layers 11 (step AS5). The address electrodes D1 are covered by the second additional dielectric layers 12.

After the completion of step AS5, a high γ dielectric material is used to form a protective layer for covering the surfaces of the transparent electrode 2, the first additional dielectric layers 11 and the second additional dielectric layers 12 (step AS6).

In the manufacturing process B for the back glass substrate 5, a white dielectric layer 6 is first formed on the front-facing face of the back glass substrate 5 (step BS1). After the white dielectric layer 6 has been formed in step BS1, a partition wall unit 7 is formed (step BS2).

Then, after the partition wall unit 7 has been formed in step BS2, red, green and blue phosphor layers 8 are each formed in the areas defined by the partition wall unit 7 (step BS3). Then, a sealing layer is formed on the periphery edge portion of the front-facing face of the back glass substrate 5 (step BS4).

The front glass substrate 1 with the various structures thus formed thereon in the manufacturing process A and the back glass substrate 5 with the various structures thus formed thereon in the manufacturing process B are placed on each other with precise alignment so as to form a discharge space between them (step CS1). Then, the step of sealing the discharge space between the front glass substrate 1 and the back glass substrate 5 (step CS2), the step of baking and removing the gases from the discharge space (step CS3), the step of introducing a discharge gas into the discharge space (step CS4), and the step of sealing the discharge gas inside (tip-off) (step CS5) are performed in order to fabricate a PDP 10.

### Second Embodiment

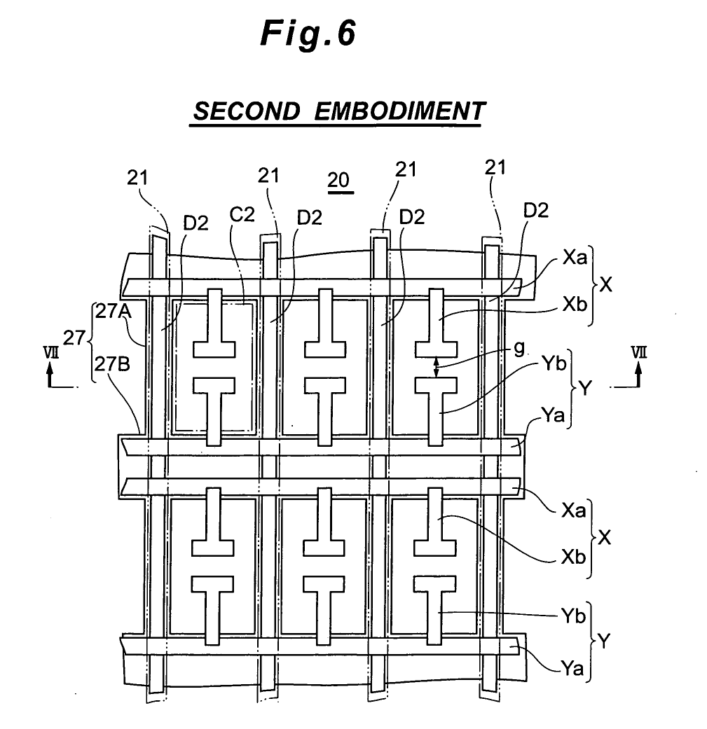

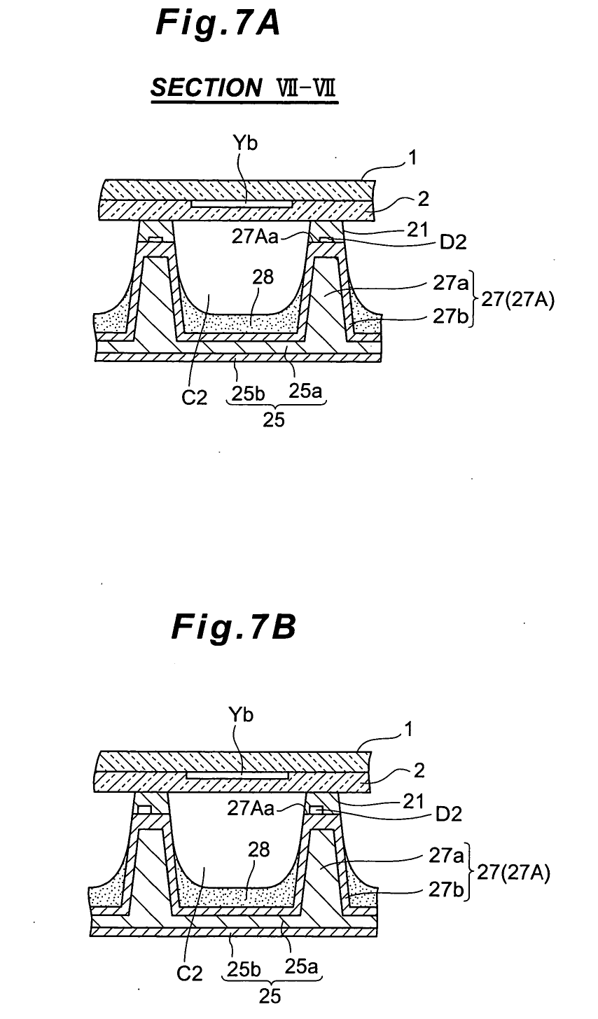

FIGS. 6, 7A and 7B illustrate a second embodiment of a PDP according to the present invention. FIG. 6 is a schematic front view of the PDP in the second embodiment. FIGS. 7A and 7B are sectional views taken along the VII-VII line in FIG. 6.

In FIGS. 6, 7A and 7B, the PDP 20 has a plurality of sustain electrode pairs (X, Y) extending in the row direction (the right-left direction in FIG. 6) and regularly arranged in the column direction (the vertical direction in FIG. 6) on the rear-facing face of a front glass substrate 1 which serves as the display surface of the PDP.

Each of the sustain electrodes X and Y constituting a sustain electrode pair (X, Y) is composed of a bus electrode Xa (Ya) extending in a bar shape in the row direction, and transparent electrodes Xb (Yb) which are spaced at regular intervals along the bus electrode Xa (Ya) and each extend from the bus electrode Xa (Ya) toward their counterparts in the sustain electrode pair, so that the transparent electrodes Xb and Yb face each other across a discharge gap g.

A transparent dielectric layer 2 is formed on the rear-facing face of the front glass substrate 1 so as to cover the sustain electrode pairs (X, Y).

The above structure is the same as the structure of the PDP 10 described in the first embodiment. The same components are designated by the same reference numerals.

A protective layer (not shown) formed of a high γ dielectric material such as MgO is formed on the rear-facing face of the transparent dielectric layer 2 and covers its surface.

A back substrate 25, which is placed opposite the front glass substrate 1 with a discharge space in between, is formed integrally with a partition wall unit 27 by the use of a metal material.

More specifically, for the back substrate 25 and the partition wall unit 27, a metal grid 27a constituting the partition wall unit 27 and having a shape described later is formed integrally on a metal plate 25a constituting the back substrate 25. The surfaces of the metal plate 25a and the metal grid 27a are respectively covered by an insulation film 25b and an insulation film 27b.

The partition wall unit 27 is formed substantially in a grid shape of vertical walls 27A and transverse walls 27B. Each of the vertical walls 27A extends in the column direction along a strip area opposite to the approximately intermediate positions between transparent electrodes Xb(Yb) regularly spaced along the associated bus electrodes Xa (Ya) of the sustain electrodes X (Y) formed on the front glass substrate 1. Each of the transverse walls 7B extends in the row direction along a strip area opposite to the bus electrodes Xa and Ya of the back-to-back sustain electrodes X and Y of the adjacent sustain electrode pairs (X, Y) and to the area between the bus electrodes Xa and Ya.

Each of the vertical walls 27A of the partition wall unit 27 has a leading face 27Aa facing the front glass substrate 1, and an address electrode D2 extends in the column direction on the leading face 27Aa.

The address electrode D2 can be formed, as illustrated in FIG. 7A, in a central portion of the leading face 27Aa of the vertical wall 27, namely, along a strip area opposite to the substantially intermediate positions between transparent electrodes Xb (Yb) regularly arranged in the row direction. However, as shown in FIG. 7B, the address electrode D2 is formed preferably, on the leading face 27Aa of the vertical wall 27, in a position shifted in the direction of the transparent electrode Yb (on the left hand in FIG. 7B in the example), in order to ensure the initiation of an address discharge between the address electrode D2 and the transparent electrode Yb which is to be paired with this address electrode D2 as described later, and to prevent a false discharge between the address electrode D2 and an adjacent unrelated transparent electrode Yb.

A dielectric cover layer 21 is formed on the leading face 27Aa of each of the vertical walls 27A and covers the address electrode D2 formed on the leading end 27Aa of the vertical wall 27.

Red-, green- and blue-colored phosphor layers 28 are each formed on five faces: the side faces of the two vertical walls 27A and the two transverse walls 27B of the partition wall unit 27 and the face of the back substrate 25 surrounded by the partition wall unit 27. The red-, green- and blue-colored phosphor layers 8 are arranged in order in the row direction.

The partition wall unit 27 partitions the discharge space defined between the front glass substrate 1 and the back substrate 25 into areas each corresponding to the opposing paired transparent electrodes Xb and Yb in each sustain electrode pair (X, Y), to form discharge cells C2.

The discharge space between the front and back substrates 1 and 25 is filled with a discharge gas including xenon (Xe).

The above-mentioned PDP 20 generates an image as follows.

A reset discharge is first produced simultaneously between the sustain electrodes X and Y or between the sustain electrode Y and the address electrode D2 in all the discharge cells C2. As a result, the wall charge is erased from every portions of the transparent dielectric layer 2 facing the discharge cells C2 (or wall charge is accumulated on every portions of the transparent dielectric layer 2 facing the discharge cells C2) Then, a scan pulse is sequentially applied to one sustain electrode (the sustain electrode Y in this example) of the sustain electrode pair (X, Y), and a data pulse corresponding to the display data of the image signal is applied to the address electrode D2. Thereupon, between the address electrode D2 to which the data pulse is applied and the transparent electrode Yb of the sustain electrode Y paired with this address electrode D2, an address discharge is produced selectively in the discharge cells C2.

The address discharge results in the deposition of wall charge on the portion of the transparent dielectric layer 2 facing each of the discharge cells C2 in which the address discharge is produced (or the erasure of the wall charge on the transparent dielectric layer 2). Thus, the discharge cells C2 (light-emitting cells) each having the deposition of wall charge on the portion of the transparent dielectric layer 2 facing the discharge cell C2, and the discharge cells C2 (non-light-emitting cells) having no wall charge are distributed over the panel face.

Following that, a sustain pulse is applied to the sustain electrodes X and Y. Thereupon, a sustain discharge is initiated across the discharge gap between the opposing transparent electrodes Xb and Yb of the sustain electrodes X and Y in each of the discharge cells C2 (light-emitting cells) having the deposition of wall charge on the transparent dielectric layer 2.

In each of the discharge cells (light-emitting cells) C2, the sustain discharge allows vacuum ultraviolet light to be generated from the xenon included in the discharge gas. The vacuum ultraviolet light excites the red-, green- and blue-colored phosphor layers 28 to cause them to emit color light, thereby forming an image on matrix display.

In the PDP 20, each of the address electrodes D2 is formed on the leading face 27Aa of the vertical wall 27A of the partition wall unit 27 partitioning the discharge space into the discharge cells C2. Because of this design, the distance between the address electrode D2 and the transparent electrode Yb of the sustain electrode Y between which an address discharge is initiated is increased as compared with that in a conventional PDP. Further, as seen from FIGS. 7A and 7B, because a space is interposed between the address electrode D2 and the transparent electrode Yb of the sustain electrode Y, the electrostatic capacity between these electrodes is reduced and therefore the electric power consumption is reduced.

Further, the address electrode D2 is located substantially in the thickness direction of the panel with respect to the transparent electrode Yb of the sustain electrode Y. Hence, the address discharge initiated between these electrodes is an approximate opposite discharge. This facilitates the ease of occurrence of a discharge, leading to a drop in the address discharge voltage and widening of the address voltage margin.

The following are the reasons why the electrostatic capacity between the address electrode D2 and the transparent electrode Yb of the sustain electrode Y is reduced and the electric power consumption is reduced in the PDP 20.

Electric current typically flows when a potential difference is produced between electrodes. The larger the current flow, the larger the electrostatic capacity between the electrodes. In the PDP, the current generated by this electrostatic capacity is reactive current.

In the conventional PDP in FIG. 2, most of the electrostatic capacity between the address electrode D and the transparent electrode Yb of the sustain electrode Y is produced by the first dielectric layer 2 interposed between the address electrode D and the transparent electrode Yb. The distance between the address electrode D and the transparent electrode Yb is short. Thereby, the electrostatic capacity is increased.

However, in the PDP 20, most of the electrostatic capacity between the address electrode D2 and the transparent electrode Yb of the sustain electrode Y is produced by the transparent dielectric layer 2 and the dielectric cover layer 21 which are interposed between the address electrode D2 and the transparent electrode Yb. Accordingly, the distance between the address electrode D2 and the transparent electrode Yb is greater than that of the conventional PDP. Thereby, the electrostatic capacity is reduced in the PDP 20.

From the foregoing, it is possible to further reduce the electrostatic capacity between the address electrode D2 and the transparent electrode Yb if the dielectric cover layer 21 causing the electrostatic capacity between the address electrode D2 and the transparent electrode Yb of the sustain electrode Y is formed of a dielectric material having a small relative dielectric constant, or alternatively the thickness of the dielectric cover layer 21 is increased.

Further, the electrostatic capacity between these electrodes can be reduced by using a dielectric material having a small relative dielectric constant to form the insulation film 27b covering the metal gird 27a partially constituting the partition wall unit 27 or by increasing the thickness of the insulation film 27b because the insulation film 27b is also closely involved in the occurrence of the electrostatic capacity between the address electrode D2 and the transparent electrode Yb.

Although the transparent dielectric layer 2 is also closely involved in the occurrence of the electrostatic capacity between the address electrode D2 and the transparent electrode Yb, the transparent dielectric layer 2 needs to be formed of a transparent dielectric material because of its location closer to the display surface of the panel. For this reason, it is difficult to reduce the relative dielectric constant of the transparent dielectric layer 2.

The dielectric cover layer 21 is not required to be formed of a transparent dielectric material, as is the transparent dielectric layer 2. Hence, it is possible to reduce the relative dielectric constant of the transparent dielectric layer 2 for a reduction in electrostatic capacity.

For example, when the transparent dielectric layer 2 has a relative dielectric constant of around ten, the relative dielectric constant of the dielectric cover layer 21 is preferably set at a value falling within the range from about one to about ten.

In the foregoing PDP 20, the back substrate 25 and the partition wall unit 27 are previously formed integrally by the use of a metal material. Simplification of the manufacturing process is possible.

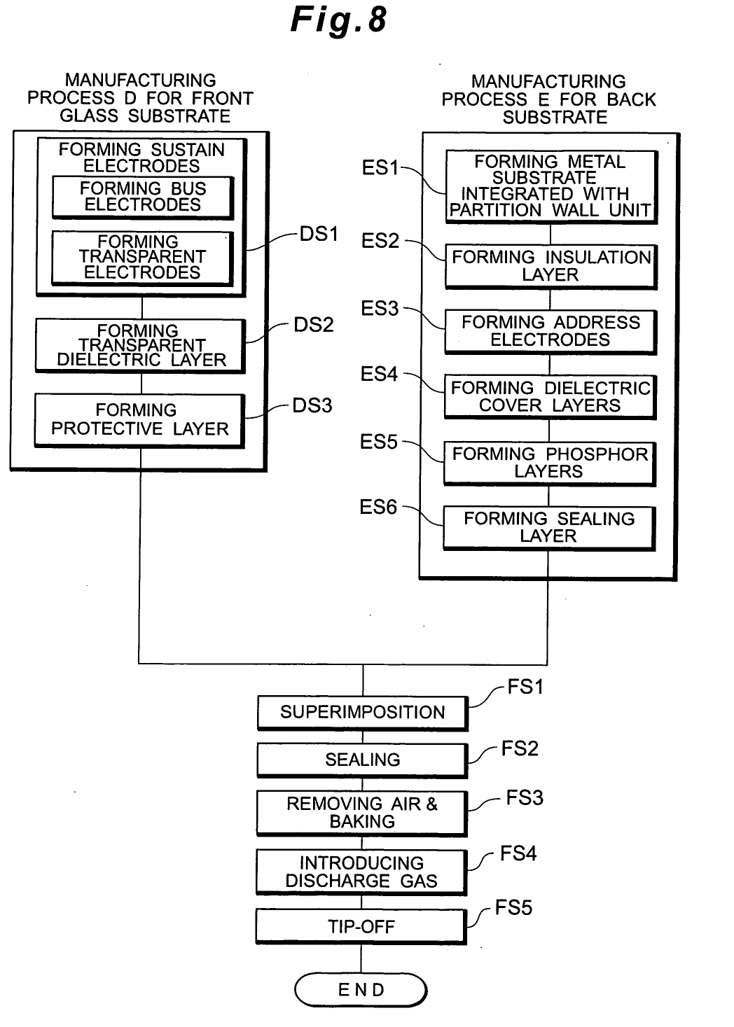

FIG. 8 shows a flowchart of the manufacturing process of the PDP 20.

Next, the manufacturing process for the PDP 20 will be described with reference to FIG. 8.

In the manufacturing process D for the front glass substrate 1, sustain electrodes X and Y are first formed on the rear-facing face of the front glass substrate 1 (step DS1).

Step DS1 includes the step of forming the bus electrodes Xa and Ya of the sustain electrodes X and Y and the step of forming the transparent electrodes Xb and Yb thereof.

After the sustain electrode pairs (X, Y) have been formed in step DS1, a transparent dielectric layer 2 is formed on the rear-facing face of the front glass substrate 1 (step DS2), so as to cover the sustain electrode pairs (X, Y) which have been formed in step DS1.

After step DS2, a high y dielectric material is used to form a protective layer for covering the surfaces of the transparent electrode 2 (step DS3).

In the manufacturing process E for the back substrate 25, a metal plate 25a and a metal grid 27a are formed integrally to form a metallic substrate (step ES1). After the metallic substrate has been formed in step ES1, insulation films 25b and 27b are formed on the surface of the metallic substrate (step ES2).

After the back substrate 25 and the partition wall unit 27 have been integrally formed in steps ES1 and ES2, address electrodes D2 are formed on the respective leading faces 27Aa of the vertical walls 27A of the partition wall unit 27 (step ES3).

After the address electrodes D2 have been formed in step ES3, dielectric cover layers 21 are formed on the respective leading faces 27Aa of the vertical walls 27A of the partition wall unit 27 (step ES4), so that the address electrodes D2 are covered by the dielectric cover layers 21.

Then, red, green and blue phosphor layers 28 are each formed in the areas defined by the partition wall unit 27 (step ES5). Then, a sealing layer is formed on the periphery edge portion of the front-facing face of the back substrate 25 (step ES6) The front glass substrate 1 with the various structures thus formed thereon in the manufacturing process D and the back substrate 25 with the various structures thus formed thereon in the manufacturing process E are placed on each other with precise alignment so as to form a discharge space between them (step FS1). Then, the step of sealing the discharge space between the front glass substrate 1 and the glass substrate 25 (step FS2), the step 2G of baking and removing the gases from the discharge space (step FS3), the step of introducing a discharge gas into the discharge space (step FS4), and the step of sealing the discharge gas inside (tip-off) (step FS5) are performed in order to fabricate a PDP 20.

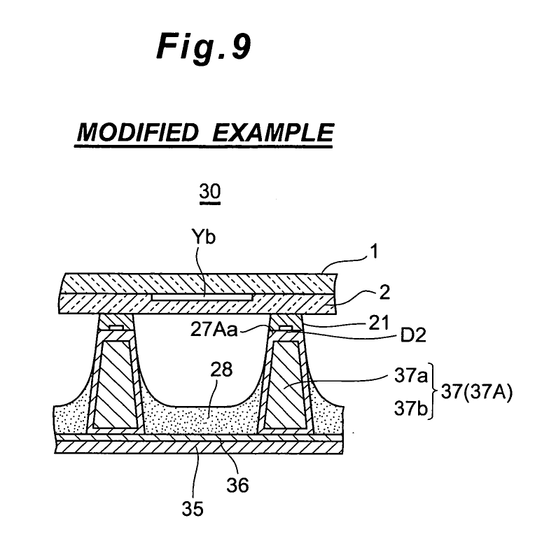

FIG. 9 illustrates an example of modification of the PDP 20 in the second embodiment. The PDP 20 has the back substrate 25 which is the metallic substrate having the partition wall unit 27 formed integrally. A PDP 30 in this example has a back glass substrate 35 formed of a glass substrate as in the case of the PDP 10 in the first embodiment. A white dielectric layer 36 is formed on the front-facing face of the back glass substrate 35.

A partition wall unit 37 is structured as a metallic partition wall in such a manner that an insulation film 37b covers the surface of a metal grid 37a.

The structure of the other components is the same as those of the PDP 20. The same components as those in the PDP 20 are designated by the same reference numerals.

As in the case of the PDP 20, it is also possible for the PDP 30 to reduce the electric power consumption and the address discharge voltage.

### Third Embodiment

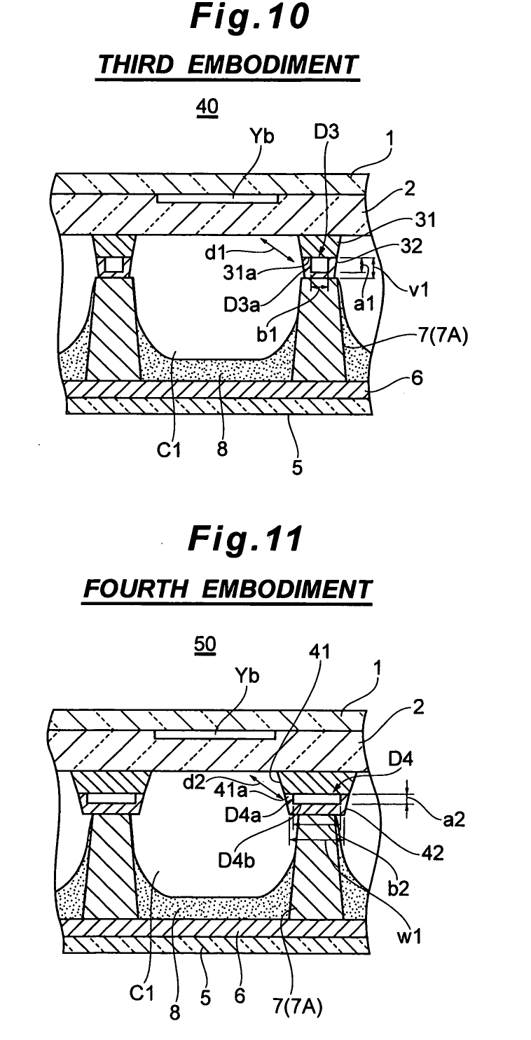

FIG. 10 is a sectional view illustrating a third embodiment according to the present invention. The sectional view of FIG. 10 shows a PDP in the third embodiment taken along the same position as that of FIG. 4A of the first embodiment (the line IV-IV in FIG. 3).

As in the case of the PDP in the first embodiment, in FIG. 10, the PDP 40 has a transparent dielectric layer 2 covering sustain electrode pairs (only a transparent electrode Yb is shown in FIG. 10) which are formed on the rear-facing face of the front glass substrate 1. First additional dielectric layers 31 are spaced at regular intervals in the row direction on the rear-facing face of the transparent dielectric layer 2. Each of the first additional dielectric layers 31 projects from the rear-facing face of the transparent dielectric layer 2 and extends in the column direction along the strip area opposite to the approximately intermediate positions between two transparent electrodes arranged at regular intervals along the bus electrode of the sustain electrode.

Each of the first additional dielectric layers 31 has a leading face 31a facing the back glass substrate 5 in parallel. An address electrode D3 is formed on each leading face 31a and extends in the column direction. The address electrode D3 is covered by a second additional dielectric layer 32 that is formed on the first dielectric layer 31.

The address electrode D3 of the PDP 40 has a thickness al (the length in the direction parallel to the thickness direction of the front glass substrate 1 and the back glass substrate 5) which is set at a value equal to one-tenth or more of the width b1 (the length in the direction parallel to the front glass substrate land the back glass substrate 5) and below the thickness v1 (the length in the direction parallel to the thickness direction of the front glass substrate 1 and the back glass substrate 5) of the second additional dielectric layer 32.

For example, in the case when the PDP is of around 50-inch diagonal, when the width b1 of the address electrode D3 is set at 50 μm and the thickness v1 of the second additional dielectric layer 32 is set at 15 μm, the thickness al of the address electrode D3 is set at a value ranging from 5 μm or more to less than 15 μm.

The structure of the other components is the same as those in the first embodiment. In FIG. 10, the same components as those of the PDP in the first embodiment are designated by the same reference numerals as those in FIGS. 3 and 4A.

When the dimensions of the address electrode D3 are determined in this manner, the following technical effects are exerted.

More specifically, as shown in FIG. 10, when an address discharge d1 is produced between the address electrode D3 and the transparent electrode Yb, the effective electrode area of the address electrode D3 (i.e. the area of the electrode involved in the discharge) corresponds to the area of the side face D3a of the address electrode D3 facing the discharge cell C1.

Therefore, when the address electrode D3 has a small effective electrode area, an address discharge is hard to initiate. In the PDP 40, because the thickness a1 of the address electrode D3 is set at a value equal to one-tenth or more of the width b1, it is possible to ensure an adequate effective electrode area. Thus, an address discharge easily occurs. In addition to the technical effects described in the first embodiment, a further drop in the address discharge voltage is possible.

In the foregoing, the reason why the thickness a1 of the address electrode D3 is set at a value less than the thickness v1 of the second additional dielectric layer 32 is for the purpose of completely covering the address electrode D3 with the second additional dielectric layer 32.

The foregoing has described the case when the dimensions of the address electrode are determined in the PDP having the same structure of that of the PDP of the first embodiment. In a like manner, the dimensions of an address electrode in a PDP of the same structure as that in the PDP in the second embodiment can be determined.

More specifically, in a PDP of the same structure as that in the second embodiment, the thickness (in the direction parallel to the thickness direction of the front glass substrate and the back substrate) of the address electrode formed on the leading face of the vertical wall of the partition wall unit defining the discharge cells is set at a value equal to one-tenth or more of the width of the address electrode in the direction parallel to the row direction, and below the thickness (in the direction parallel to the thickness direction of the front glass substrate and the back substrate) of the dielectric cover layer covering the address electrodes. Thus, similarly, an address discharge is easy to initiate and the address discharge voltage is further reduced.

### Fourth Embodiment

FIG. 11 is a sectional view illustrating a fourth embodiment according to the present invention. The sectional view of FIG. 11 shows a PDP in the fourth embodiment taken along the same position as that of FIG. 4A of the first embodiment (the line IV-IV in FIG. 3).

As in the case of the PDP in the first embodiment, in FIG. 11, the PDP 50 has a transparent dielectric layer 2 covering sustain electrode pairs (only a transparent electrode Yb is shown in FIG. 11) which are formed on the rear-facing face of the front glass substrate 1. First additional dielectric layers 41 are spaced at regular intervals in the row direction on the rear-facing face of the transparent dielectric layer 2. Each of the first additional dielectric layers 41 projects from the rear-facing face of the transparent dielectric layer 2 and extends in the column direction along the strip area opposite to the substantially intermediate positions between two transparent electrodes arranged at regular intervals along the bus electrode of the sustain electrode.

Each of the first additional dielectric layers 41 has a leading face 41a facing the back glass substrate 5 in parallel. An address electrode D4 is formed on each leading face 41a and extends in the column direction. The address electrode D4 is covered by a second additional dielectric layer 42 that is formed on the first dielectric layer 41.

The address electrode D4 of the PDP 50 has a width b2 (the length in the direction parallel to the front glass substrate 1 and the back glass substrate 5) which is set at a value equal to ten or more times the thickness a2 (the length in the direction parallel to the thickness direction of the front glass substrate 1 and the back glass substrate 5) and below the width w1 (the length in the direction parallel to the front glass substrate 1 and the back glass substrate 5) of the second additional dielectric layer 42.

For example, in the case where the PDP is of around 50-inch diagonal, when the thickness a2 of the address electrode D4 is set at 5 μm and the width w1 of the second additional dielectric layer 42 is set at 70 μm, the width b2 of the address electrode D4 is set at a value ranging from 50 μm or more to less than 70 μm.

The structure of the other components is thee same as those in the first embodiment. In FIG. 11, the same components as those of the PDP in the first embodiment are designated by the same reference numerals as those in FIGS. 3 and 4A.

When the dimensions of the address electrode D4 are determined in this manner, the following technical effects are exerted.

More specifically, when an address discharge d2 is produced between the address electrode D4 and the transparent electrode Yb, the effective electrode area of the address electrode D4 (i.e. the area of the electrode involved in the discharge) corresponds to the area of the side face D4a of the address electrode D4 facing the discharge cell C1. Therefore, when the address electrode D4 has a small thickness a2 and a small effective electrode area, an address discharge is hard to initiate. However, in actuality, due to electric filed diffraction, a portion of the leading face D4b (i.e. the face facing parallel to the back glass substrate 5) extending continuously from the side face D4a of the address electrode D4 is involved in the address discharge d2.

Therefore, in the PDP 50, in order to substantially enlarge the effective electrode area of the address electrode D4, the width b2 of the address electrode D4 is set at a value equal to ten or more times the thickness a2. Thus, an address discharge easily occurs. In addition to the technical effects described in the first embodiment, a further drop in the address discharge voltage is possible.

In the foregoing, the reason why the width b2 of the address electrode D4 is set at a value less than the width w1 of the second additional dielectric layer 42 is for the purpose of completely covering the address electrode D4 with the second additional dielectric layer 42.

The foregoing has described the case when the dimensions of the address electrode are determined in the PDP having the same structure of that of the PDP of the first embodiment. In a like manner, the dimensions of an address electrode in a PDP of the same structure as that in the PDP in the second embodiment can be determined.

More specifically, in a PDP of the same structure as that in the second embodiment, the width (in the direction parallel to the row direction) of the address electrode formed on the leading face of the vertical wall of the partition wall unit defining the discharge cells is set at a value equal to ten or more times the thickness of the address electrode in the direction parallel to the thickness direction of the front glass substrate and the back substrate, and below the width (in the direction parallel to the row direction) of the dielectric cover layer covering the address electrodes. Thus, similarly, an address discharge is easy to initiate and the address discharge voltage is further reduced.

### Fifth Embodiment

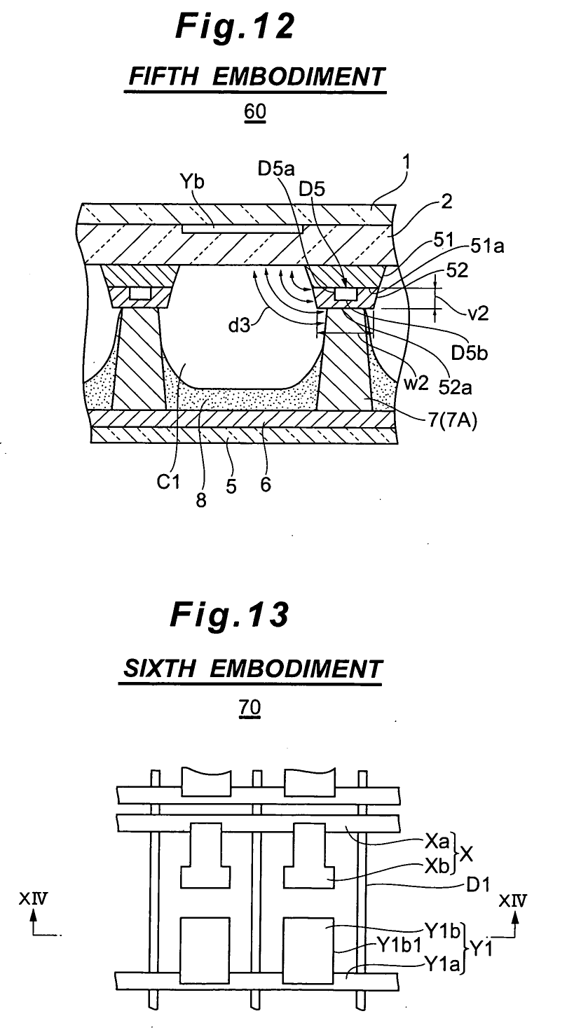

FIG. 12 is a sectional view illustrating a fifth embodiment according to the present invention. The sectional view of FIG. 12 shows a PDP in the fifth embodiment taken along the same position as that of FIG. 4A of the first embodiment (the line IV-IV in FIG. 3).

As in the case of the PDP in the first embodiment, in FIG. 12, the PDP 60 has a transparent dielectric layer 2 covering sustain electrode pairs (only a transparent electrode Yb is shown in FIG. 12) which are formed on the rear-facing face of the front glass substrate 1. First additional dielectric layers 51 are spaced at regular intervals in the row direction on the rear-facing face of the transparent dielectric layer 2. Each of the first additional dielectric layers 51 projects from the rear-facing face of the transparent dielectric layer 2 and extends in the column direction along the strip area opposite to the substantially intermediate positions between two transparent electrodes arranged at regular intervals along the bus electrode of the sustain electrode.

Each of the first additional dielectric layers 51 has a leading face 51a facing the back glass substrate 5 in parallel. An address electrode D5 is formed on each leading face 51a and extends in the column direction. The address electrode D5 is covered by a second additional dielectric layer 52 that is formed on the first dielectric layer 51.

The second additional dielectric layer 52 of the PDP 60 has a width w2 (the length in the direction parallel to the front glass substrate 1 and the back glass substrate 5) which is set at a value equal to 4.5 or more times the width v2 (the length in the direction parallel to the thickness direction of the front glass substrate 1 and the back glass substrate 5).

For example, in the case where the PDP is of around 50-inch diagonal, when the thickness v2 of the second additional dielectric layer 52 is set at 15 μm, the width w2 of the second additional dielectric layer 52 is set at 67.5 μm or more, more preferably, at 70 μm or more.

An upper limit of the width w2 of the second additional dielectric layer 52 is set at a value equal to or smaller than the width of the first additional dielectric layer 51.

This is because, if the width w2 of the second additional dielectric layer 52 is wider than the width of the first additional dielectric layer 51, stable formation of the second additional dielectric layer 52 is impossible from a structure viewpoint.

The structure of the other components is the same as those in the first embodiment. In FIG. 12, the same components as those of the PDP in the first embodiment are designated by the same reference numerals as those in FIGS. 3 and 4A.

When the dimensions of the second additional dielectric layer 52 are determined in this manner, the following technical effects are exerted.

More specifically, when an address discharge d3 is produced between the address electrode D5 and the transparent electrode Yb, the effective electrode area of the address electrode D5 (i.e. the area of the electrode involved in the discharge) corresponds to the area of the side face D5a of the address electrode D5 facing the discharge cell C1. Therefore, when the address electrode D5 has a small thickness and a small effective electrode area, an address discharge is hard to initiate. However, if the width of the second additional dielectric layer 52 in increased, as shown in FIG. 12, this diffracts the discharge path of the address discharge d3 towards the leading face 52b (i.e. the face facing parallel to the back glass substrate 5) of the second additional dielectric layer 52. As a result, the leading face D5b of the address electrode D5 is also involved in the address discharge d3.

Therefore, in the PDP 60, in order to substantially enlarge the effective electrode area of the address electrode D5, the width w2 of the second additional dielectric layer 52 is set at a value equal to 4.5 times or more the thickness v2. Thus, an address discharge easily occurs. In addition to the technical effects described in the first embodiment, a further drop in the address discharge voltage is possible.

The foregoing has described the case when the dimensions of the second additional dielectric layer are determined in the PDP having the same structure of that of the PDP of the first embodiment. In a like manner, the dimensions of a second additional dielectric layer in a PDP of the same structure as that in the PDP in the second embodiment can be determined.

More specifically, in a PDP of the same structure as that in the second embodiment, the width (in the direction parallel to the row direction) of the dielectric cover layer covering the address electrode formed on the leading face of the vertical wall of the partition wall unit defining the discharge cells is set at a value equal to 4.5 or more times the thickness of the dielectric cover layer in the direction parallel to the thickness direction of the front glass substrate and the back substrate. Further, the width of the dielectric cover layer in the direction parallel to the row direction is set at a value equal to or less than the width of the vertical wall of the partition wall unit in the direction parallel to the row direction. Thus, similarly, an address discharge is easy to initiate and the address discharge voltage is further reduced.

### Sixth Embodiment

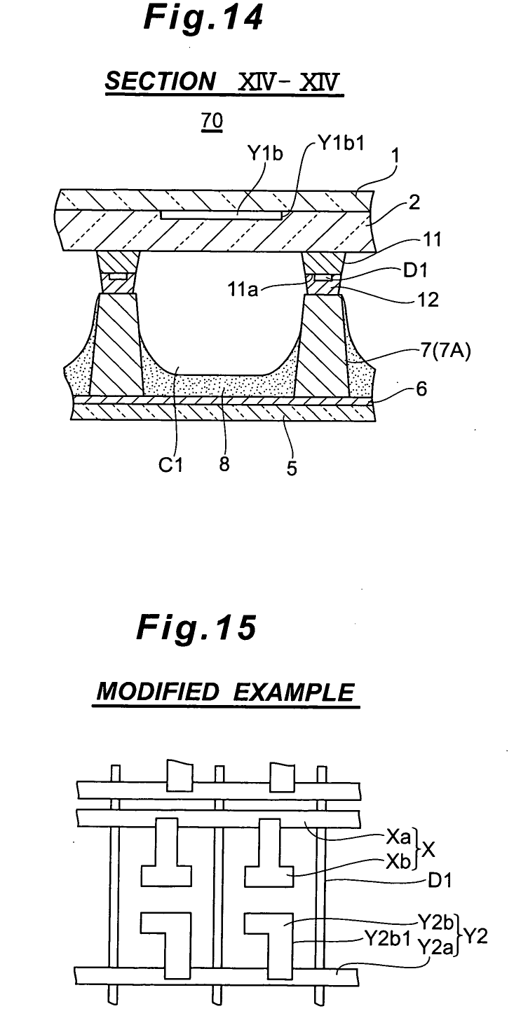

FIGS. 13 and 14 illustrate a sixth embodiment according to the present invention. FIG. 13 is a schematic front view of a PDP of the sixth embodiment. FIG. 14 is a sectional view taken along the XIV-XIV line in FIG. 13.

In FIGS. 13 and 14, a transparent electrode Y1b of a sustain electrode Y1 out of sustain electrodes constituting each sustain electrode pair has an approximate I shape. A side portion Y1b1 located close to an address electrode D1 which is to be paired with the sustain electrode Y1 when an address discharge is produced extends linearly parallel to the address electrode D1.

The structure of the other components is the same as those in the first embodiment. In FIGS. 13 and 14, the same components as those of the PDP in the first embodiment are designated by the same reference numerals as those in FIGS. 3 and 4A.

In the PDP 70, the side portion of Y1b1 of the transparent electrode Y1b of the sustain electrode Y1 located closer to the address electrode D1 extends linearly parallel to the address electrode D1, so that the area of the transparent electrode Y1b contributing to the address discharge is increased as compared with the case of the substantially T-shaped transparent electrode as described in the first embodiment. Thus, an address discharge easily occurs. In addition to the technical effects described in the first embodiment, a further drop in the address discharge voltage is possible.

Further, what is required of the shape of the transparent electrode of the sustain electrode for an address discharge is that a side portion thereof positioned close to the address electrode extends linearly parallel to the address electrode, and is not limited to the shape illustrated in FIG. 13. For example, as shown in FIG. 15, a transparent electrode Y2b of a sustain electrode Ys may be formed substantially in a L shape that a side portion Y2b1 close to the address electrode D1 for an address discharge extends linearly in parallel to the address electrode D1.

The formation of the transparent electrode Y2b of the sustain electrode Y2 in an approximate L shape (a recess is formed in the side portion opposite the side portion facing toward the address electrode D1 which initiates an address discharge in conjunction with the transparent electrode Y2b) as shown in FIG. 15, means an increase in the distance between the transparent electrode Y2b and an unrelated address electrode D1 located opposite to the address electrode D1, paired with the transparent electrode Y2b for producing the address discharge, with the transparent electrode Y2 in between. This increased distance leads to prevention of a false discharge from occurring between the transparent electrode and the unrelated address electrode D1 located opposite to the address electrode D1 which is paired with the transparent electrode Y2b for producing the address discharge.

Note that the other sustain electrode X of the sustain electrode pair can be formed in various shapes, such as an approximate T shape as shown in FIGS. 13 and 15, an approximate I shape similar to the shape of the transparent electrode Y1b of the sustain electrode Y1 shown in FIG. 13, or an approximate L shape similar to the shape of the transparent electrode Y2b of the sustain electrode Y2 shown in FIG. 15.

The foregoing has described the case of changing the shape of the sustain electrode initiating an address discharge in conjunction with the address electrode in the PDP having the same structure of that of the PDP of the first embodiment. Likewise, when, in a PDP which is identical in structure with the PDP in the second embodiment, the shape of the sustain electrode initiating an address discharge in conjunction with the address electrode is changed, an address discharge is easy to initiate and the address discharge voltage is further reduced.

The terms and description used herein are set forth by way of illustration only and are not meant as limitations. Those skilled in the art will recognize that numerous variations are possible within the spirit and scope of the invention as defined in the following claims.

1. A plasma display panel having: a front substrate and a back substrate placed opposite each other on either side of a discharge space; a plurality of row electrode pairs extending in a row direction and regularly arranged in a column direction on a rear-facing face of the front substrate; a dielectric layer formed on the rear-facing face of the front substrate and covering the row electrode pairs; and a plurality of column electrodes extending in the column direction and regularly arranged in the row direction, and initiating a discharge in conjunction with one row electrode of the row electrode pair in each unit light-emitting area defined in the discharge space, comprising:
a plurality of first ridged dielectric layers that protrude from a rear-facing face of the dielectric layer, extend in the column direction, and are regularly arranged in the row direction, each of the column electrodes being formed on the first ridged dielectric layer.

2. A plasma display panel according to claim 1, wherein each of the first ridged dielectric layer is formed on a position of the rear-facing face of the dielectric layer corresponding to a boundary area between the unit light-emitting areas adjacent to each other in the row direction.

3. A plasma display panel according to claim 1, further comprising a second ridged dielectric layer formed on each of the first ridged dielectric layers and covering the column electrode formed on the first ridged dielectric layer.

4. A plasma display panel according to claim 1, wherein each of the column electrodes is formed on a face of the first ridged dielectric layer facing toward the back substrate.

5. A plasma display panel according to claim 1, wherein
each of the row electrodes constituting each row electrode pair has an electric body extending in the row direction and a plurality of electrode protruding portions arranged at regular intervals along the electrode body and each extending out from the electrode body toward its counterpart row electrode to face its counterpart electrode protruding portion with a discharge gap in between, and
each of the column electrodes is situated in a strip area opposite to substantially intermediate positions between adjacent electrode protruding portions regularly arranged along the associated electrode bodies of the row electrodes.

6. A plasma display panel according to claim 5, wherein each of the column electrodes is situated in a position shifted in the direction of the electrode protruding portion initiating a discharge in conjunction with the column electrode, between the adjacent electrode protruding portions regularly arranged along the electrode body of the row electrode.

7. A plasma display panel according to claim 1, wherein a relative dielectric constant of the first ridged dielectric layer is smaller than a relative dielectric constant of the dielectric layer covering the row electrode pairs.

8. A plasma display panel according to claim 3, wherein a relative dielectric constant of the second ridged dielectric layer is smaller than a relative dielectric constant of the dielectric layer covering the row electrode pairs.

9. A plasma display panel having: a front substrate and a back substrate placed opposite each other on either side of a discharge space; a plurality of row electrode pairs extending in a row direction and regularly arranged in a column direction on a rear-facing face of the front substrate; a dielectric layer formed on the rear-facing face of the front substrate and covering the row electrode pairs; and a plurality of column electrodes extending in the column direction and regularly arranged in the row direction, and initiating a discharge in conjunction with one row electrode of the row electrode pair in each unit light-emitting area defined in the discharge space, comprising:
a partition wall unit formed on the back substrate and extending at least in column direction to block off the adjacent unit light-emitting areas in the row direction from each other, wherein the column electrodes are formed on the partition wall unit.

10. A plasma display panel according to claim 9, wherein the column electrodes are formed on a face of the partition wall unit facing toward the front substrate.

11. A plasma display panel according to claim 9, wherein each of the row electrodes constituting each row electrode pair has an electric body extending in the row direction and a plurality of electrode protruding portions arranged at regular intervals along the electrode body and each extending out from the electrode body toward its counterpart row electrode to face its counterpart electrode protruding portion with a discharge gap in between, and
each of the column electrodes is situated in a strip area opposite to substantially intermediate positions between adjacent electrode protruding portions regularly arranged along the associated electrode bodies of the row electrodes.

12. A plasma display panel according to claim 11, wherein each of the column electrodes is situated in a position shifted in the direction of the electrode protruding portion initiating a discharge in conjunction with the column electrode, between the adjacent electrode protruding portions regularly arranged along the electrode body of the row electrode.

13. A plasma display panel according to claim 9, further comprising a dielectric cover layer formed on the partition wall unit and covering each of the column electrodes.

14. A plasma display panel according to claim 13, wherein a relative dielectric constant of the dielectric cover layer is smaller than a relative dielectric constant of the dielectric layer covering the row electrode pairs.

15. A plasma display panel according to claim 9, wherein the partition wall unit is formed of a metal-made base and an insulation layer covering the base, and the column electrodes are formed on the insulation layer.

16. A plasma display panel according to claim 15, wherein a relative dielectric constant of the insulation layer is smaller than a relative dielectric constant of the dielectric layer covering the row electrode pairs.

17. A plasma display panel according to claim 15, wherein the back substrate is formed of a metal-made base and an insulation layer covering the base, and the metal-made base of the back substrate and the metal-made base of the partition wall are formed integrally with each other.

18. A plasma display panel according to claim 3, wherein a thickness of the column electrode in a direction parallel to a thickness direction of the front substrate and the back substrate is set at a value equal to one-tenth or more of a width of the column electrode in a direction parallel to the row direction and below a thickness of the second ridged dielectric layer in a direction parallel to the thickness direction of the front substrate and the back substrate.

19. A plasma display panel according to claim 13, wherein a thickness of the column electrode in a direction parallel to a thickness direction of the front substrate and the back substrate is set at a value equal to one-tenth or more of a width of the column electrode in a direction parallel to the row direction and below a thickness of the dielectric cover layer in a direction parallel to the thickness direction of the front substrate and the back substrate.

20. A plasma display panel according to claim 3, wherein a width of the column electrode in a direction parallel to the row direction is set at a value equal to ten or more times a thickness of the column electrode in a direction parallel to a thickness direction of the front substrate and the back substrate and below a width of the second ridged dielectric layer in a direction parallel to the row direction.

21. A plasma display panel according to claim 13, wherein a width of the column electrode in a direction parallel to the row direction is set at a value equal to ten or more times a thickness of the column electrode in a direction parallel to a thickness direction of the front substrate and the back substrate and below a width of the dielectric cover layer in a direction parallel to the row direction.

22. A plasma display panel according to claim 3, wherein a width of the second ridged dielectric layer in a direction parallel to the row direction is set at a value equal to 4.5 or more times a thickness of the second ridged dielectric layer in a direction parallel to a thickness direction of the front substrate and the back substrate.

23. A plasma display panel according to claim 22, wherein the width of the second ridged dielectric layer in the direction parallel to the row direction is set at a value either equal to a width of the first ridged dielectric layer in a direction parallel to the row direction or below the width of the first ridged dielectric layer.

24. A plasma display panel according to claim 3, wherein a width of the dielectric cover layer in a direction parallel to the row direction is set at a value equal to 4.5 or more times a thickness of the dielectric cover layer in a direction parallel to a thickness direction of the front substrate and the back substrate.

25. A plasma display panel according to claim 24, wherein the width of the dielectric cover layer in the direction parallel to the row direction is set at a value either equal to a width of a portion of the partition wall unit blocking off the adjacent unit light-emitting areas in the row direction from each other, in the direction parallel to the row direction, or below the width of the portion of the partition wall unit.

26. A plasma display panel according to claim 5, wherein almost all of a side portion, facing toward the column electrode, of the electrode protruding portion initiating a discharge in conjunction with the column electrode linearly extends substantially parallel to the column electrode.

27. A plasma display panel according to claim 26, wherein a recess is formed in a side portion partially forming the electrode protruding portion initiating a discharge in conjunction with the column electrode, and positioned opposite to the side portion facing toward the column electrode.

28. A plasma display panel according to claim 11, wherein almost all of a side portion, facing toward the column electrode, of the electrode protruding portion initiating a discharge in conjunction with the column electrode linearly extends substantially parallel to the column electrode.

29. A plasma display panel according to claim 28, wherein a recess is formed in a side portion partially forming the electrode protruding portion initiating a discharge in conjunction with the column electrode, and positioned opposite to the side portion facing toward the column electrode.
